(19) United States
(12) Patent Application Publication
(10) Pub. No.: US 2018/0329610 A1
(43) Pub. Date: Nov. 15, 2018

(54) Object Selection Mode

(71) Applicant: Microsoft Technology Licensing, LLC, Redmond, WA (US)

(72) Inventors: Eduardo SONNINO, Vancouver (CA); Anthony DART, Redmond, WA (US); Ryan Chandler PENDLAY, Bellevue, WA (US); Jason M. NELSON, Sammamish, WA (US); Andrew Michael CASEY, Redmond, WA (US); March ROGERS, Bothell, WA (US); Peter HAMMERQUIST, Shoreline, WA (US); Aaron Naoyoshi Sheung Yan WOO, Bellevue, WA (US); Callil R. CAPUOZZO, Brooklyn, NY (US); Christian James COLANDO, Seattle, WA (US); Laurentiu PAVEL, Bellevue, WA (US); Jenny Angelica ALARCO DIEZ, Seattle, WA (US)

(73) Assignee: Microsoft Technology Licensing, LLC, Redmond, WA (US)

(21) Appl. No.: 15/636,402

(22) Filed: Jun. 28, 2017

Related U.S. Application Data
(60) Provisional application No. 62/506,499, filed on May 15, 2017.

(51) Int. Cl. G06F 3/0484; G06F 3/0488; G06F 3/14

(52) U.S. Cl. CPC G06F 3/04842; G06F 3/04845; G06F 3/0483; G06F 3/1423; G06F 3/0488

(57) ABSTRACT

Techniques for object selection mode are described. In one or more implementations, digital content is generated as an interactive canvas, and the interactive canvas is displayed on one or more display devices of a computing device. Additional digital content is also displayed on the interactive canvas as one or more objects. The one or more objects are anchored to the interactive canvas in an anchor mode which prevents user input to the interactive canvas from being interpreted as input to manipulate the one or more objects. A trigger event to trigger an object selection mode is detected, and an object selection mode is initiated in response to the trigger event. The object selection mode causes user input to the interactive canvas to be interpreted as input to manipulate the one or more objects.

### RELATED APPLICATION

This application claims priority to U.S. Provisional Application No. 62/506,499, filed May 15, 2017, entitled “Object Selection Mode”, the disclosure of which is hereby incorporated by reference herein in its entirety.

### BACKGROUND

Increasingly, users interact with devices by providing user input to touch displays using a stylus or the user's finger. Using a stylus makes it easy for the user to provide “free-form” input to the display device, such as by writing or drawing on the display device. However, when the primary input device used to interact with the device is a stylus or the user's finger, it can be difficult for users to initiate other functions, such as moving objects, resizing objects, accessing menus, and so forth, without initiating free-form input. For example, it can be difficult for a user to adjust the size of a photo displayed on the display using a stylus. Furthermore, in many cases, user frustration occurs when user input intended to be interpreted as input to manipulate an object, is instead interpreted as writing input, and vice versa.

### SUMMARY

Techniques for object selection mode are described. In one or more implementations, digital content is generated as an interactive canvas, and the interactive canvas is displayed on one or more display devices of a computing device. Additional digital content is also displayed on the interactive canvas as one or more objects. The one or more objects are anchored to the interactive canvas in an anchor mode which prevents user input to the interactive canvas from being interpreted as input to manipulate the one or more objects. A trigger event to trigger an object selection mode is detected, and an object selection mode is initiated in response to the trigger event. The object selection mode causes user input to the interactive canvas to be interpreted as input to manipulate the one or more objects.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ techniques for object selection mode discussed herein.

FIG. 2 illustrates a system showing the object selection module of FIG. 1 in more detail.

FIGS. 3A to 3E illustrate various examples of object selection mode in accordance with one or more implementations.

FIG. 4 is a flow diagram that describes steps in a method for object selection mode in accordance with one or more implementations.

FIG. 5 illustrates an example system that includes an example computing device that is representative of one or more computing systems and/or devices that may implement the various techniques described herein.

### DETAILED DESCRIPTION

Techniques for object selection mode are described. Generally, the techniques described herein create a clear separation between an anchor mode in which objects are anchored to an interactive canvas and user input the interactive canvas is digitized and displayed, and an object selection mode in which user input is interpreted as input to manipulate objects. In addition, the described techniques enable the user to quickly and efficiently switch between the anchor mode and the object selection mode, while also providing visual indicators which identify the mode that is currently active, thereby reducing user confusion and frustration.

In one or more implementations, digital content is generated as an interactive canvas, and the interactive canvas is displayed on one or more display devices of a computing device. Additional digital content is also displayed on the interactive canvas as one or more objects. The one or more objects are anchored to the interactive canvas in an anchor mode which prevents user input to the interactive canvas from being interpreted as input to manipulate the one or more objects. For example, in the anchor mode, the user is unable to move or resize the objects. Instead, user input to the interactive canvas (e.g., via a stylus) is digitized and displayed on the interactive canvas as additional digital content. Thus, the user can freely write and draw on the interactive canvas without concern that the user input may be interpreted as input to manipulate objects in the interactive canvas.

While the user is writing or drawing in the anchor mode, the system monitors for a trigger event to switch from the anchor mode to an object selection mode. In response to detecting the trigger event, the object selection mode is initiated. The object selection mode causes user input to the interactive canvas to be interpreted as input to manipulate the one or more objects in the interactive canvas, while preventing the user input from being digitized and displayed on the interactive canvas. Thus, in the object selection mode, the user can manipulate objects in the interactive canvas in a variety of different ways without concern that the user input may be interpreted as writing input for display.

In one or more implementations, the trigger event to trigger the object selection mode corresponds to a user selection of one of multiple objects displayed on the interactive canvas (e.g., by tapping and holding an object). In response to this single trigger event, the object selection mode enables manipulation of each of multiple objects in the interactive canvas without requiring the user to select each object first. In other words, the single user action to select one of the objects in the interactive canvas causes all of the objects in the interactive canvas to be “un-anchored” from the interactive canvas such that all of the objects can be freely manipulated by the user.

While the user is manipulating objects in the object selection mode, the system monitors for an additional trigger event to switch from the object selection mode back to the anchor mode. In response to detecting the additional trigger event, the object selection mode is disabled and the anchor mode is initiated. In some cases, the additional trigger event corresponds to a user section of an area of the interactive canvas that does not include an object.

In one or more implementations, the system provides a visual indication of the currently active mode. For example, the object selection mode can be indicated by visually altering the digital content of one or more objects in the interactive canvas, such as by displaying a drop shadow around one or more of the objects. Doing so provides a clear indication to the user that the object selection mode is active while also visually identifying all of the objects which can be manipulated.

Thus, the described techniques enable the user to quickly and efficiently toggle back and forth between the anchor mode in order to write on the interactive canvas, and the object selection mode in order to manipulate objects, even when a stylus or the user's finger is used as the primary input device. Further, the described techniques provide a clear visual indication of the currently active mode, thereby reducing user confusion and frustration.

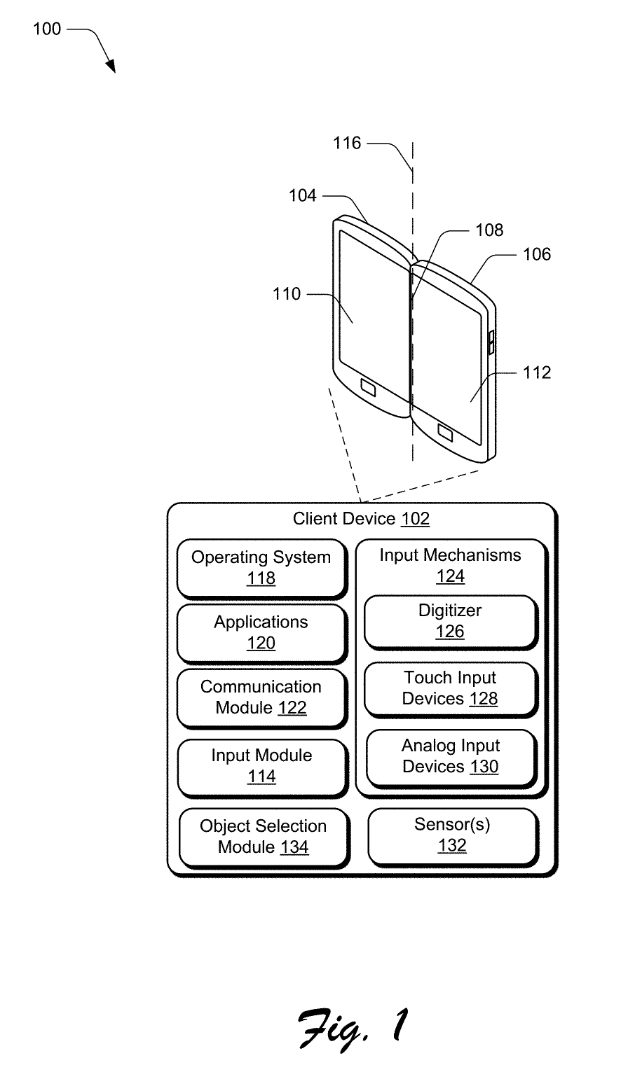

FIG. 1 is an illustration of an environment 100 in an example implementation that is operable to employ techniques for object selection mode discussed herein. Environment 100 includes a client device 102 which can be configured for mobile use, such as a mobile phone, a tablet computer, a wearable device, a handheld gaming device, a media player, and so on. In this example, the client device 102 is implemented as a “dual-display” device, and includes a display device 104 and a display device 106 that are connected to one another by a hinge 108. The display device 104 includes a touch surface 110, and the display device 106 includes a touch surface 112. The client device 102 also includes an input module 114 configured to process input received via one of the touch surfaces 110, 112 and/or via the hinge 108. While some of the techniques discussed herein will be described with reference to a dual-display device, it is to be appreciated that in some cases the techniques may also be implemented on a single-screen device, such as a mobile phone, tablet computer, media player, laptop computer, desktop computer, and so forth. In addition, the hinge 108 may allow the display devices 104 and 106 to fold back on each other to provide a “single display” device. As such, the techniques described herein may be designed to function whether the user is operating in a two-display mode or a single-display mode. In addition, while the dual display device is illustrated with a hinge in this example, it is to be appreciated that in some cases the techniques may be implemented in single display, dual-display, or multi-display devices without the hinge.

The hinge 108 is configured to rotationally move about a longitudinal axis 116 of the hinge 108 to allow an angle between the display devices 104, 106 to change. In this way, the hinge 108 allows the display devices 104, 106 to be connected to one another yet be oriented at different angles and/or planar orientations relative to each other. In at least some implementations, the touch surfaces 110, 112 may represent different portions of a single integrated and continuous display surface that can be bent along the hinge 108.

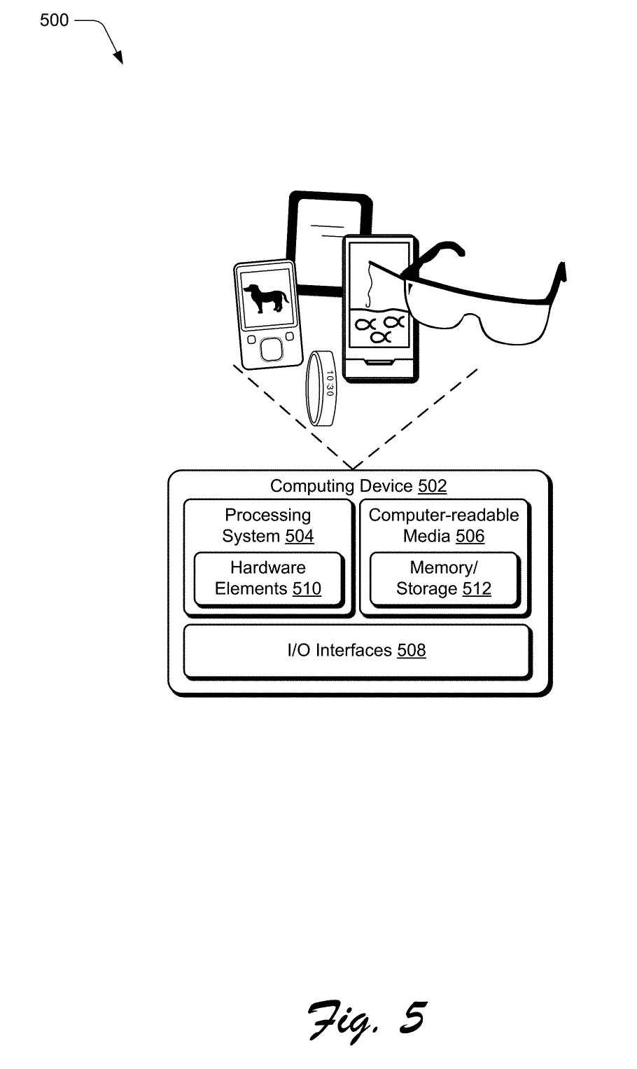

While implementations presented herein are discussed in the context of a mobile device, it is to be appreciated that various other types and form factors of devices may be utilized in accordance with the claimed implementations. Thus, the client device 102 may range from full resource devices with substantial memory and processor resources, to a low-resource device with limited memory and/or processing resources. An example implementation of the client device 102 is discussed below with reference to FIG. 5.

The client device 102 includes a variety of different functionalities that enable various activities and tasks to be performed. For instance, the client device 102 includes an operating system 118, applications 120, and a communication module 122. Generally, the operating system 118 is representative of functionality for abstracting various system components of the client device 102, such as hardware, kernel-level modules and services, and so forth. The operating system 118, for instance, can abstract various components (e.g., hardware, software, and firmware) of the client device 102 to enable interaction between the components and applications running on the client device 102.

The applications 120 are representative of functionality for performing different tasks via the client device 102. In one particular implementation, the applications 120 represent a web browser, web platform, or other application that can be leveraged to browse websites over a network.

The communication module 122 is representative of functionality for enabling the client device 102 to communicate over wired and/or wireless connections. For instance, the communication module 122 represents hardware and logic for communicating data via a variety of different wired and/or wireless technologies and protocols.

According to various implementations, the display devices 104, 106 generally represent functionality for visual output for the client device 102. Additionally, the display devices 104, 106 represent functionality for receiving various types of input, such as touch input, stylus input, touchless proximity input, and so forth via one or more of the touch surfaces 110, 112, which can be used as visual output portions of the display devices 104, 106. The input module 114 is representative of functionality to enable the client device 102 to receive input (e.g., via input mechanisms 124) and to process and route the input in various ways.

The input mechanisms 124 generally represent different functionalities for receiving input to the client device 102, and include a digitizer 126, touch input devices 128, and analog input devices 130. Examples of the input mechanisms 124 include gesture-sensitive sensors and devices (e.g., such as touch-based sensors), a stylus, a touch pad, accelerometers, a microphone with accompanying voice recognition software, and so forth. The input mechanisms 124 may be separate or integral with the display devices 104, 106; integral examples include gesture-sensitive displays with integrated touch-sensitive sensors.

The digitizer 126 represents functionality for converting various types of input to the display devices 104, 106, the touch input devices 128, and the analog input devices 130 into digital data that can be used by the client device 102 in various ways. The analog input devices 130 represent hardware mechanisms (e.g., the hinge 108) that are usable to generate different physical quantities that represent data. For instance, the hinge 108 represents a mechanism that can be leveraged to generate input data by measurement of a physical variable, such as hinge angle of the hinge 108. One or more sensors 132, for example, can measure the hinge angle, and the digitizer 126 can convert such measurements into digital data usable by the client device 102 to display digital content via the display devices 104, 106.

Generally, the sensors 132 represent functionality for detecting different input signals received by the client device 102. For example, the sensors 132 can include one or more hinge sensors configured to detect a hinge angle between the display devices 104, 106. Additionally, the sensors 132 can include grip sensors, such as touch sensors, configured to detect how a user is holding the client device 102. Accordingly, a variety of different sensors 132 can be implemented to detect various different types of digital and/or analog input. These and other aspects are discussed in further detail below.

In one particular implementation, the applications 120 represent a journal application which display digital content as an interactive canvas representative of pages of a journal. For example, a first page of the journal application can be displayed as digital content on touch surface 110 of display device 104 while a second page of the journal application is displayed as digital content on touch surface 112 of display device 106. The user can then write and draw on the interactive canvas, as well as insert and/or manipulate various different objects.

In one or more implementations, the applications 120 include or otherwise make use of an object selection module 134. The object selection module 134, for example, represents a standalone application. In other implementations, the object selection module 134 is included as part of another application or system software, such as the operating system 118 of the journal application. Generally, the object selection module enables the user to efficiently transition between an anchor mode in which objects are anchored to the interactive canvas and user input is digitized and displayed as digital content on the interactive canvas, and an object selection mode which causes user input to the interactive canvas to be interpreted as user input to select and manipulate the objects. Further discussion of this and other features is provided below.

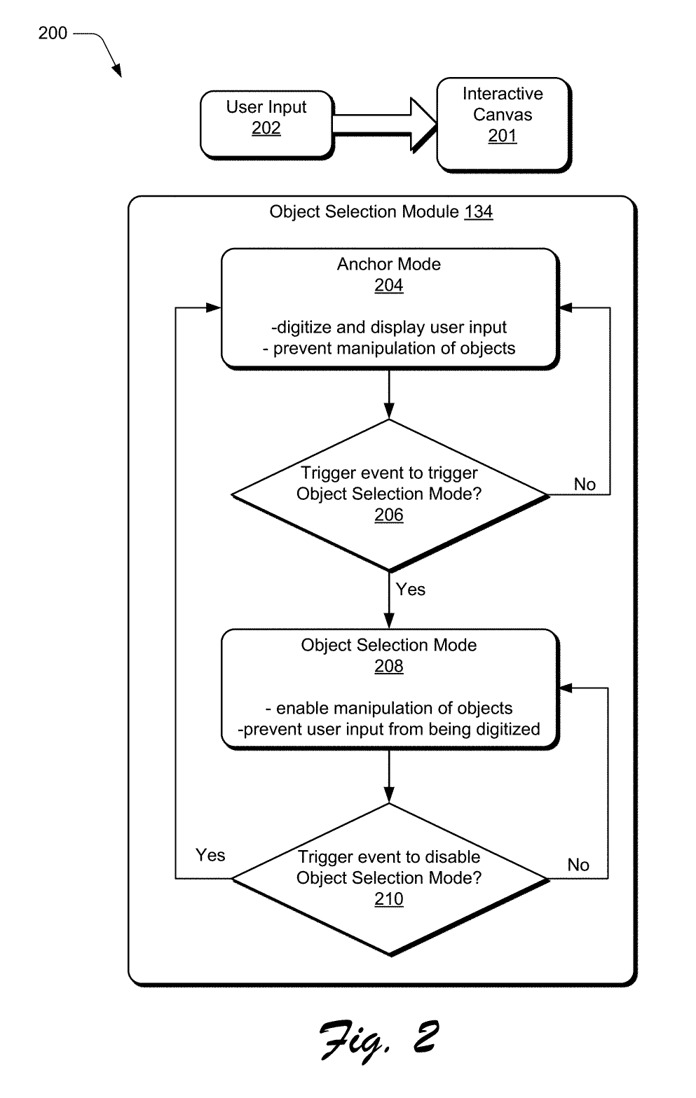

FIG. 2 illustrates a system 200 showing the object selection module 134 in more detail.

In system 200, object selection module 134 generates digital content as an interactive canvas 201, and monitors user input 202 to an interactive canvas. For example, a user can interact with an interactive canvas using a stylus, the user's finger, and so forth. In an anchor mode 204, the object selection module 134 digitizes and displays the user input on the interactive canvas 201 as additional digital content, and prevents the user input from being interpreted as user input to manipulate objects in the interactive canvas.

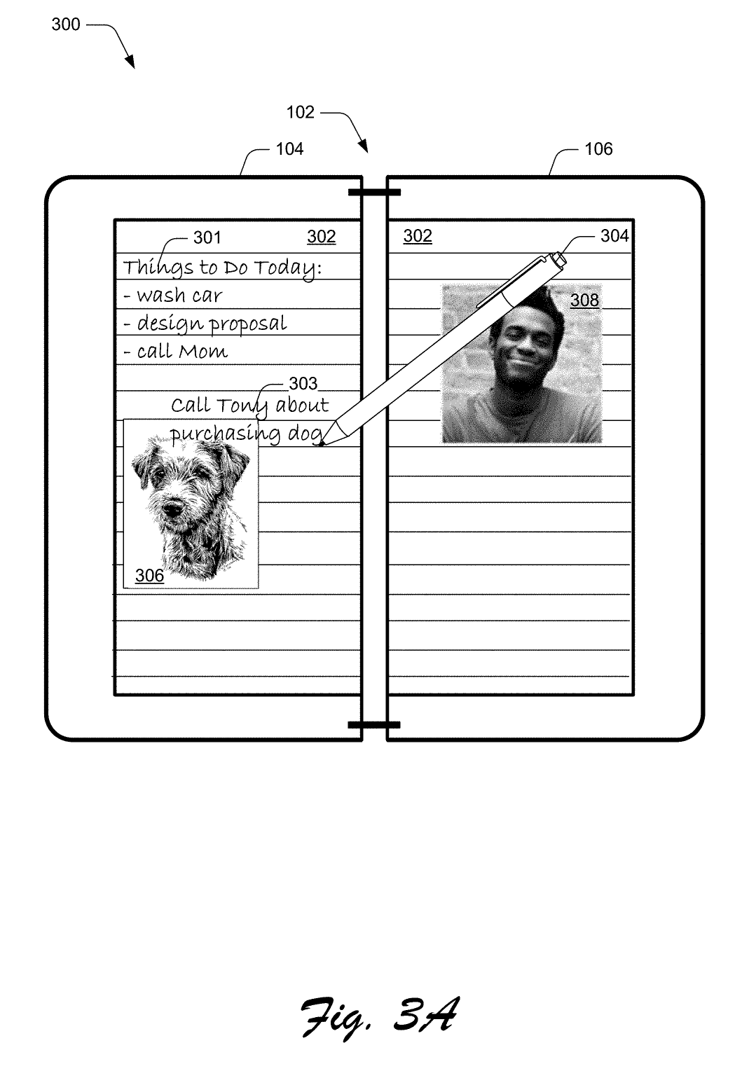

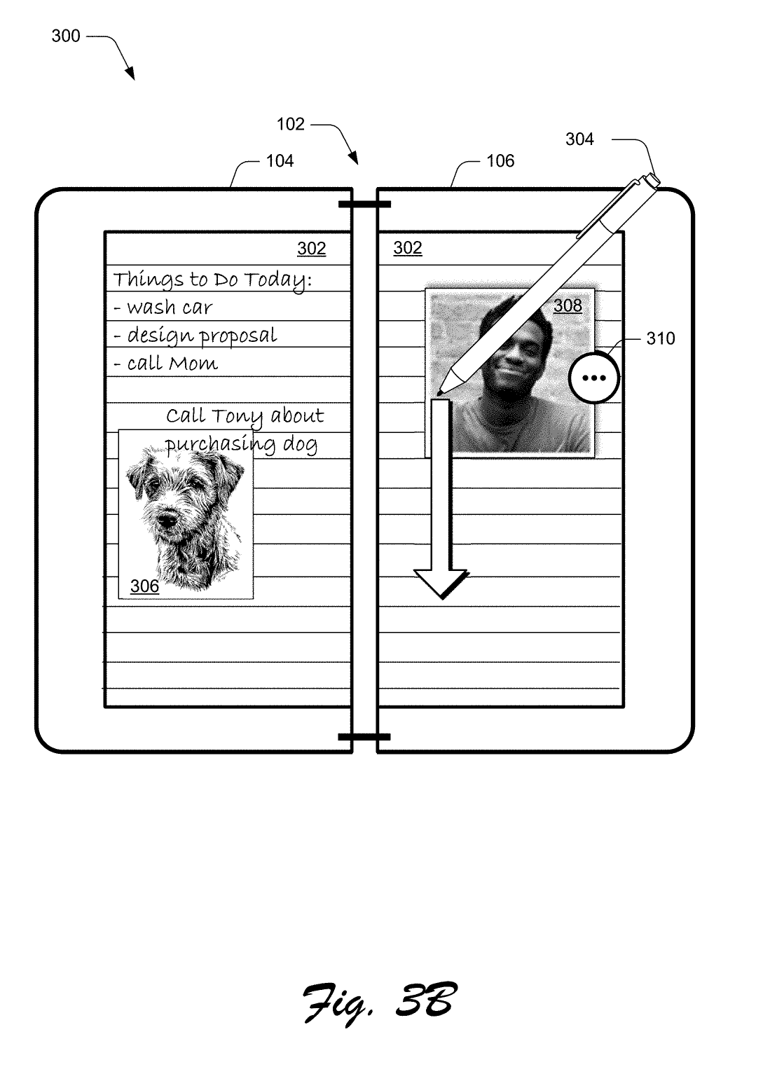

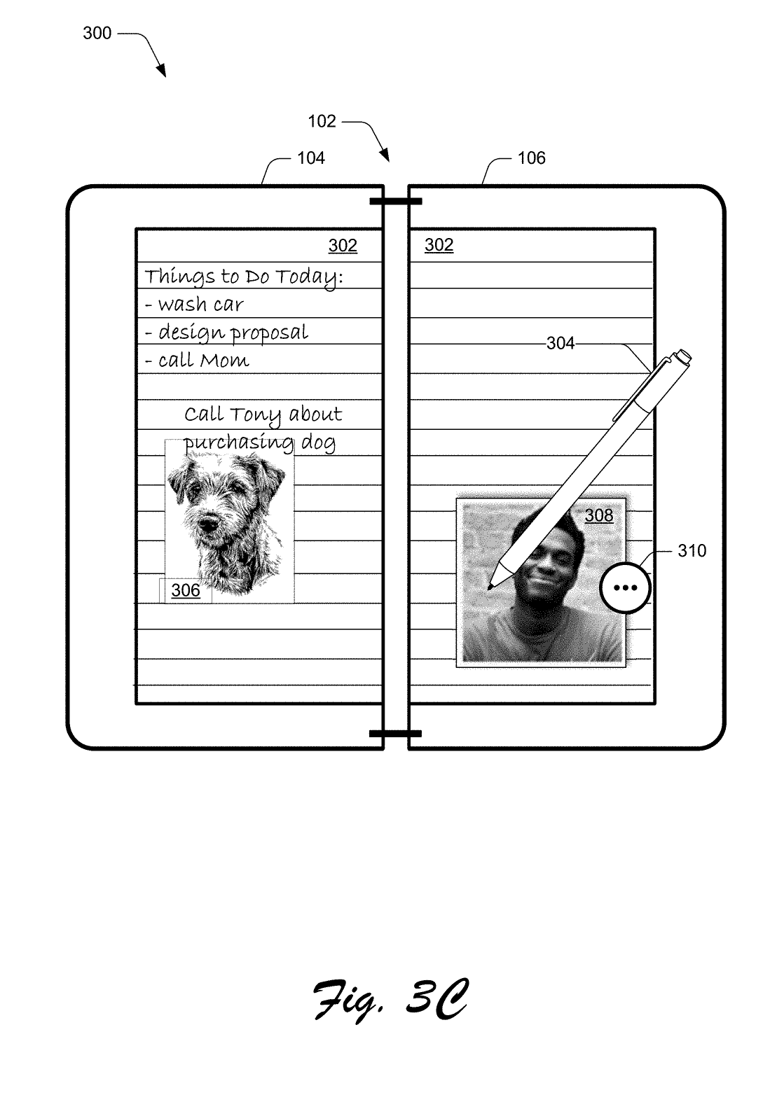

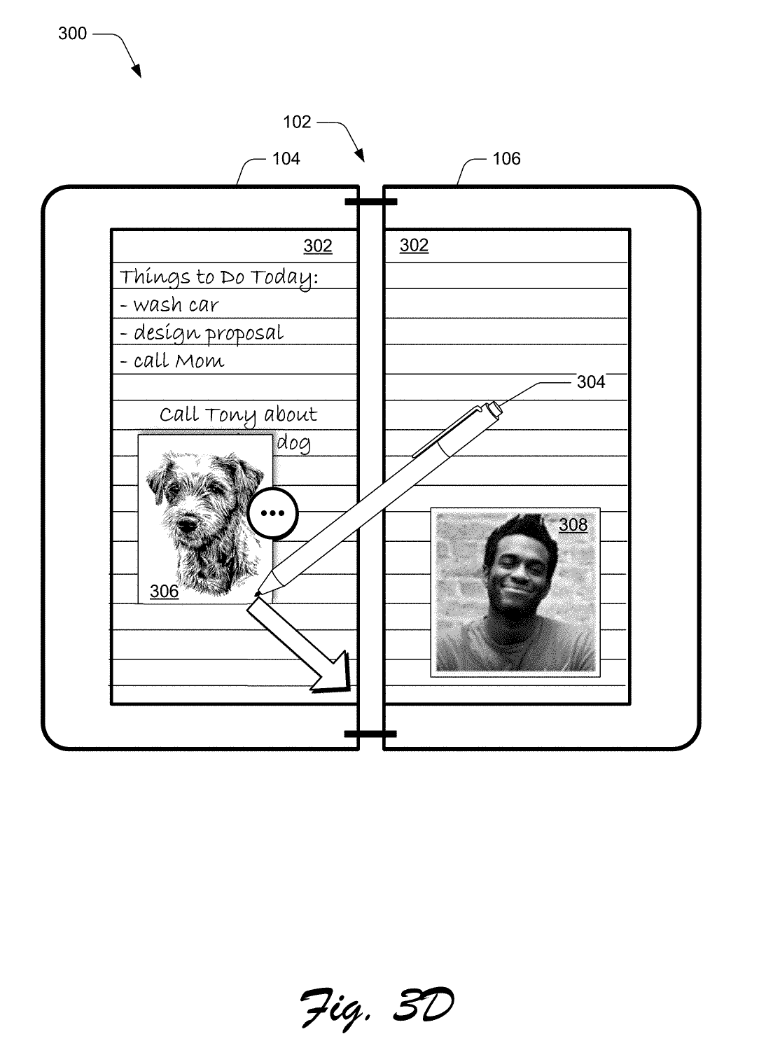

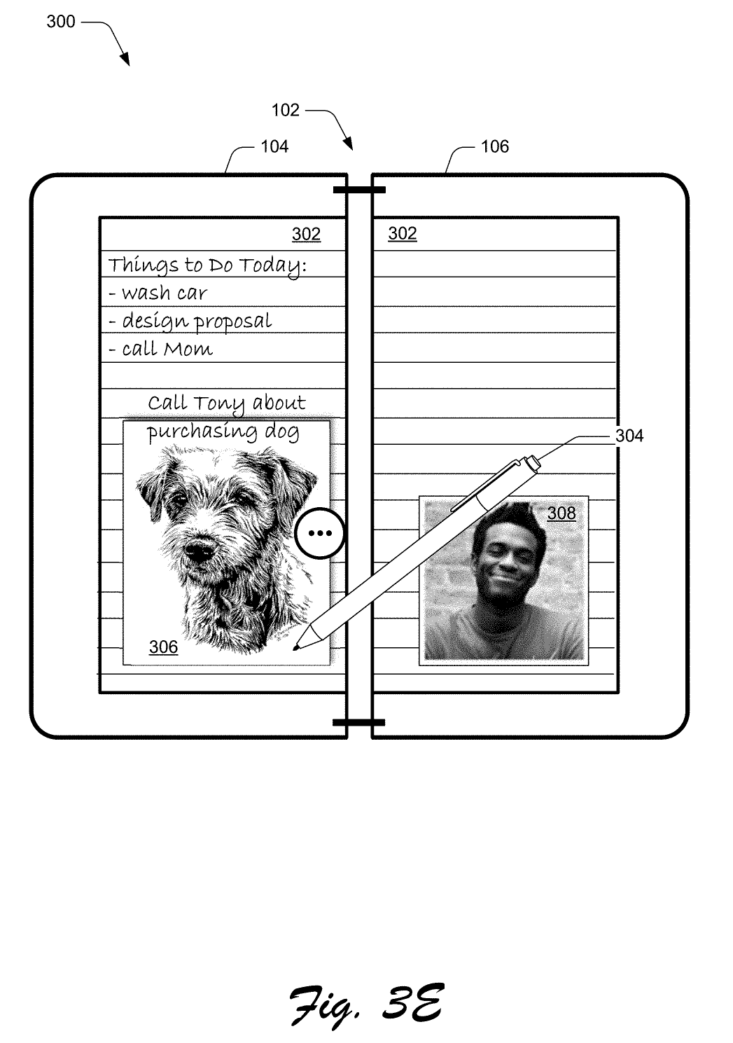

As an example, consider FIGS. 3A to 3E, which illustrate various examples 300 of object selection mode in accordance with one or more implementations.

In FIG. 3A, client device 102 displays digital content as an interactive canvas 302 on one or more displays. In this example, the digital content of interactive canvas 302 is displayed on display devices 104 and 106 of a “dual-display” client device 102 as pages of a journal application. However, as described throughout, in other cases the interactive canvas 302 may be displayed on a “single-display” device and/or associated with a different type of application. The journal application enables the user to take notes and/or draw on the interactive canvas 302 using an input device, such as a stylus 304.

In this example, the digital content of interactive canvas 302 displays additional digital content as objects 306 and 308, which correspond to a picture of a dog and a person, respectively. As described herein, objects may include any type of digital content, such as images and photos, videos, audio files, text, symbols, drawings, and so forth.

In the anchor mode 204, the object selection module 134 anchors the objects 306 and 308 to the interactive canvas 302, such that user input to the interactive canvas 302 is digitized and displayed on the interactive canvas 302 as additional digital content. In FIG. 3A, for example, the user writes on the upper left corner of the interactive canvas 302 using stylus 304. When the user input is received, digitizer 126 causes the user input to be digitized and displayed on the canvas as additional digital content 301. In this example, the user also writes “Call Tony about purchasing dog” proximate object 306, and in response, the user input is digitized and displayed on the canvas as additional digital content 303. In this example, the additional digital content 303 overlaps object 306. Conventionally, such user input may be interpreted as input to manipulate the object 306 due to the proximity of the user input to the object 306. In this case, however, since the anchor mode 204 is enabled, the object selection module 134 prevents the user input from being interpreted as input to manipulate the object 306, and instead generates the additional digital content 303 corresponding to the user input.

Referring back to FIG. 2, at 206, while the anchor mode is active, the object selection module 134 monitors for a trigger event to trigger an object selection mode. As long as the trigger event is not detected, the object selection module 134 remains in anchor mode, which enables the user to write all over the interactive canvas without accidentally manipulating objects.

However, in response to detection of the trigger event, the object selection module 134 switches from the anchor mode 204 to the object selection mode 208. In the object selection mode 208, the user input 202 is interpreted as input to manipulate objects in the interactive canvas 201, and the user input is prevented from being digitized and displayed as additional digital content on the interactive canvas 201. Notably, the object selection mode enables manipulation of each of multiple objects in the interactive canvas without an additional trigger event.

The object selection mode can be triggered in a variety of different ways. In one or more implementations, the trigger event corresponds to a user selection of one of the objects in the interactive canvas, such as by tapping and holding one of the objects with a finger or a stylus 304, or selecting a button on stylus 304 while touching one of the objects. Notably, the selection of a single object triggers the object selection mode 208 such that one or more other objects in the interactive canvas can be manipulated without an additional user selection of the one or more other objects. In other words, the single trigger event enables manipulation of each of the multiple objects in the interactive canvas without an additional trigger event.

As an example, consider FIG. 3B, in which the user triggers the object selection mode 208 by selecting object 308. For example, the user may tap and hold stylus 304 over object 308 in order to select object 308. In response to the trigger event, object selection module 134 initiates the object selection mode 208. The object selection mode 208 enables the user to manipulate all of the objects on the interactive canvas 302, which in this example includes objects 308 and 306.

In the object selection mode, the user can manipulate objects in a variety of different ways, such as by moving, resizing, or grouping the objects. In FIG. 3B, for example, after triggering the object selection mode by selecting object 308, the user controls stylus 304 to move downwards. In response, the object selection module 134 causes the digital content of object 308 to move downwards in accordance with the movement of stylus 304, which is illustrated in FIG. 3C. Notably, if the anchor mode was active instead of the object selection mode, then this same action of moving stylus 304 downwards would cause a line to be drawn on the interactive canvas 302.

In one or more implementations, the object selection module 134 provides a visual indication of the currently active mode. For example, the object selection module can provide one or more visual indicators to indicate that the object selection mode 210 is active, such as by visually altering the digital content of one or more objects in the interactive canvas. In one or more implementations, the object selection module 134 provides the visual indication by displaying a drop shadow around one or more of the objects. Doing so provides a clear indication to the user that the object selection mode is active, thereby reducing user confusion and frustration. In FIG. 3B, for example, the object selection mode causes a drop shadow to be displayed around the selected object 308 to signify that the object selection mode 208 is activated and that the object 308 is currently selected.

Alternately or additionally, the visual indication may include an icon or menu displayed proximate the selected object which can be selected in order to perform various editing operations on the selected object. In FIG. 3B, for example, an icon 310 is displayed proximate the selected object 308. In this example, icon 310 includes three dots which provides a visual cue to the user that the icon can be selected in order to see additional actions that can be applied to the selected object, such as changing shape, resizing, copying, and so forth. In some cases, the visual indication may be applied to all of the objects on the interactive canvas to signify that all of the objects can be manipulated in the object selection mode, such as by displaying a shadow and/or icon with all of the objects displayed on the interactive canvas.

As described throughout, once the object selection mode 208 is initiated, the digital content of all of the objects can be manipulated without an additional trigger event. For example, in FIG. 3D, the user moves stylus 304 to the bottom right corner of object 306, and motions down and to the right, in order to adjust the size of object 306. As shown in FIG. 3E, because the object selection mode 208 is currently active, the object selection module 134 adjusts the size of object 306 in accordance with this user input. Notably, because the object selection mode 208 has already been triggered, the user does not need to provide an additional trigger event, such as by tapping and holding object 306, prior to performing the resize action. As such, the object selection mode enables the user to quickly and easily edit all of the objects in the interactive canvas without concern that the user input to manipulate objects will be digitized and displayed on the interactive canvas as digital content.

Referring back to FIG. 2, at 210, the object selection module detects that the object selection mode is disabled, and transitions back to the anchor mode by anchoring the objects back to the interactive canvas. As long as the additional trigger event is not detected, the object selection module 134 remains in object selection mode, which enables the user to freely manipulate objects without concern that the user input will be digitized and displayed on the interactive canvas.

However, in response to the additional trigger event, the object selection module 134 switches from the object selection mode 208 to the anchor mode 204. The object selection mode 208 may be disabled in a variety of different ways. In one or more implementations, the object selection mode 208 is disabled, and the anchor mode 204 is initiated, in response to detecting a user selection to an area of the interactive canvas that does not include an object, such as by tapping and/or holding stylus 304 over an area of the interactive canvas that does not include an object. As part of the transition back to the anchor mode, the object selection module 134 may also remove the visual indicators to signal that the anchor mode is active.

In one or more implementations, one or more controls are displayed on the interactive canvas 302 in the object selection mode 208 which enables manipulation of the objects. For example, a trash can icon can be presented on the interactive canvas to enable the objects to be dragged to the trash can in order to delete the objects from the interactive canvas 302.

The following discussion describes some example procedures in accordance with one or more implementations. The example procedures may be employed in the environment 100 of FIG. 1, the system 500 of FIG. 5, and/or any other suitable environment. The procedures, for instance, represent example procedures for implementation of the scenarios described above. In at least some implementations, the steps described for the various procedures can be implemented automatically and independent of user interaction.

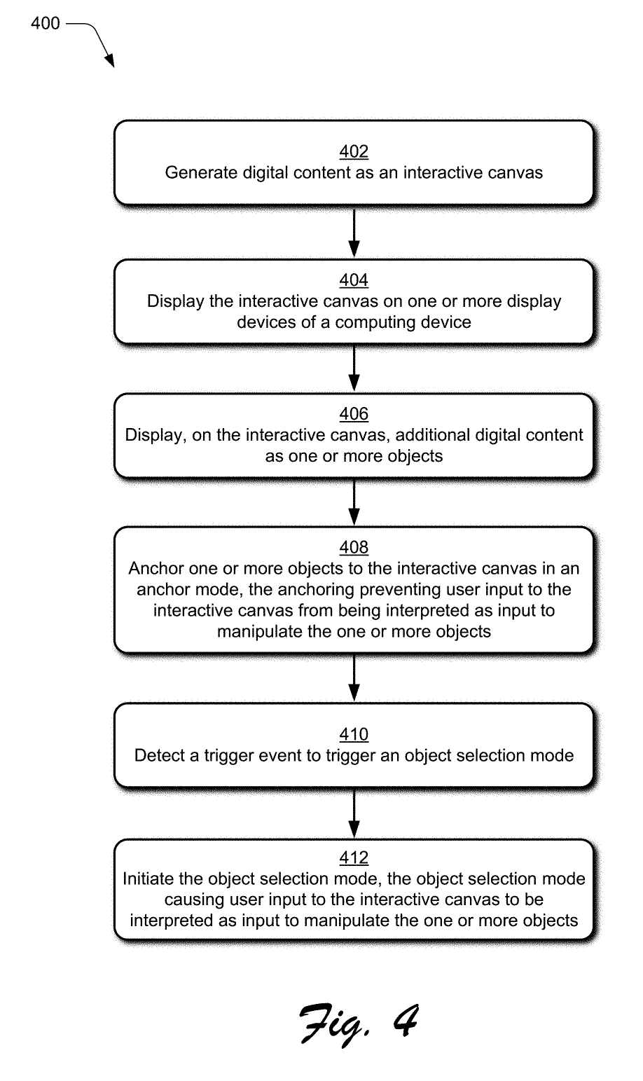

FIG. 4 is a flow diagram that describes steps in a method for object selection mode in accordance with one or more implementations.

At 402, digital content is generated as an interactive canvas, and at 404 the interactive canvas is displayed on one or more display devices of a computing device. For example, object selection module 134 generates digital content as an interactive canvas 302, and displays the interactive canvas on display devices 104 and/or 106 of client device 102.

At 406, additional digital content is displayed on the interactive canvas as one or more objects. For example, additional digital content as objects 306 and 308 are displayed on interactive canvas 302 of display devices 104 and/or 106 of client device 102.

At 408, the one or more objects are anchored to the interactive canvas in an anchor mode. For example, object selection module 134 anchors objects 306 and 308 to interactive canvas 302 in anchor mode 204. The anchoring prevents user input to the interactive canvas from being interpreted as input to manipulate the one or more objects. For example, in the anchor mode, user input to the interactive canvas is digitized and displayed on the interactive canvas as additional digital content.

At 410, a trigger event to trigger an object selection mode is detected. For example, object selection module 134 detects a trigger event to trigger object selection mode 208, such as when the user taps and holds a stylus over one of the objects 306 or 308 displayed on interactive canvas 302.

At 412, the object selection mode is initiated in response to the trigger event. The object selection mode causes user input to the interactive canvas to be interpreted as input to manipulate the one or more objects. For example, object selection module 134 initiates object selection mode 208 to cause user input to interactive canvas 302 to be interpreted as input to manipulate objects 306 or 308.

FIG. 5 illustrates an example system generally at 400 that includes an example computing device 502 that is representative of one or more computing systems and/or devices that may implement the various techniques described herein. In at least some implementations, the computing device 502 represents an implementation of the client device 102 discussed above, such as a dual-display device. The computing device 502 may, for example, be configured to assume a mobile configuration through use of a housing formed and sized to be grasped and carried by one or more hands of a user, illustrated examples of which include a mobile phone, mobile game and music device, and tablet computer although other examples are also contemplated. In at least some implementations, the client device 102 may be implemented as a wearable device, such as a smart watch, smart glasses, a dual-surface gesture-input peripheral for a computing device, and so forth.

The example computing device 502 as illustrated includes a processing system 504, one or more computer-readable media 506, and one or more I/O interface 508 that are communicatively coupled, one to another. Although not shown, the computing device 502 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 504 is representative of functionality to perform one or more operations using hardware. Accordingly, the processing system 504 is illustrated as including hardware element 510 that may be configured as processors, functional blocks, and so forth. This may include implementation in hardware as an application specific integrated circuit or other logic device formed using one or more semiconductors. The hardware elements 510 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 506 is illustrated as including memory/storage 512. The memory/storage 512 represents memory/storage capacity associated with one or more computer-readable media. The memory/storage component 512 may include volatile media (such as random access memory (RAM)) and/or nonvolatile media (such as read only memory (ROM), Flash memory, optical disks, magnetic disks, and so forth). The memory/storage component 512 may include fixed media (e.g., RAM, ROM, a fixed hard drive, and so on) as well as removable media (e.g., Flash memory, a removable hard drive, an optical disc, and so forth). The computer-readable media 506 may be configured in a variety of other ways as further described below.

Input/output interface(s) 508 are representative of functionality to allow a user to enter commands and information to computing device 502, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 502 may be configured in a variety of ways to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 502. By way of example, and not limitation, computer-readable media may include “computer-readable storage media” and “computer-readable signal media.”

“Computer-readable storage media” may refer to media and/or devices that enable persistent storage of information in contrast to mere signal transmission, carrier waves, or signals per se. Thus, computer-readable storage media refers to non-signal bearing media and does not include signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 502, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 510 and computer-readable media 506 are representative of modules, programmable device logic and/or fixed device logic implemented in a hardware form that may be employed in some implementations to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 510. The computing device 502 may be configured to implement particular instructions and/or functions corresponding to the software and/or hardware modules. Accordingly, implementation of a module that is executable by the computing device 502 as software may be achieved at least partially in hardware, e.g., through use of computer-readable storage media and/or hardware elements 510 of the processing system 504. The instructions and/or functions may be executable/operable by one or more articles of manufacture (for example, one or more computing devices 502 and/or processing systems 504) to implement techniques, modules, and examples described herein.

Example implementations described herein include, but are not limited to, one or any combinations of one or more of the following examples:

In one or more examples, a method implemented by one or more computing devices comprises: generating digital content as an interactive canvas; displaying the interactive canvas on one or more display devices of a computing device; displaying, on the interactive canvas, additional digital content as one or more objects; anchoring the one or more objects to the interactive canvas in an anchor mode, the anchoring preventing user input to the interactive canvas from being interpreted as input to manipulate the one or more objects; detecting a trigger event to trigger an object selection mode; and initiating the object selection mode in response to the trigger event, the object selection mode causing user input to the interactive canvas to be interpreted as input to manipulate the one or more objects.

An example as described alone or in combination with any of the other examples described above or below, wherein the object selection mode is configured to prevent the user input to the interactive canvas from being digitized and displayed as additional digital content on the interactive canvas.

An example as described alone or in combination with any of the other examples described above or below, wherein the anchor mode causes user input to the interactive canvas to be digitized and displayed on the interactive canvas as additional digital content.

An example as described alone or in combination with any of the other examples described above or below, wherein the object selection mode enables manipulation of each of multiple objects in the interactive canvas without an additional trigger event.

An example as described alone or in combination with any of the other examples described above or below, wherein the trigger event comprises a user selection of one of the objects anchored to the interactive canvas.

An example as described alone or in combination with any of the other examples described above or below, wherein the user selection comprises tapping and holding the object.

An example as described alone or in combination with any of the other examples described above or below, wherein the trigger event comprising the user selection of one of the objects enables manipulation of one or more other objects in the interactive canvas without an additional user selection of the one or more other objects.

An example as described alone or in combination with any of the other examples described above or below, further comprising displaying one or more visual indicators to indicate that the object selection mode is active.

An example as described alone or in combination with any of the other examples described above or below, further comprising disabling the object selection mode and initiating the anchor mode in response to detecting an additional trigger event to disable the object selection mode.

An example as described alone or in combination with any of the other examples described above or below, wherein the additional trigger event to disable the object selection mode comprises an additional user selection of an area of the interactive canvas that does not include an object.

An example as described alone or in combination with any of the other examples described above or below, wherein the interactive canvas is displayed on the one or more display devices as pages of a journal application.

In one or more examples, a computing device comprises: one or more display devices; at least one processor; and at least one computer-readable storage media storing instructions that are executable by the at least one processor to: display an interactive canvas on the one or more display devices of the computing device; anchor one or more objects to the interactive canvas in an anchor mode, the anchoring causing user input to the interactive canvas to be digitized and displayed on the interactive canvas; detect a trigger event to trigger an object selection mode; and initiate the object selection mode in response to the trigger event, the object selection mode causing user input to the interactive canvas to be interpreted as input to manipulate the one or more objects.

An example as described alone or in combination with any of the other examples described above or below, wherein the object selection mode is further configured to prevent the user input to the interactive canvas from being digitized and displayed on the interactive canvas.

An example as described alone or in combination with any of the other examples described above or below, wherein the anchor mode is further configured to prevent user input to the interactive canvas from being interpreted as input to manipulate the one or more objects.

An example as described alone or in combination with any of the other examples described above or below, wherein the trigger event comprises a user selection of one of the objects anchored to the interactive canvas.

An example as described alone or in combination with any of the other examples described above or below, wherein the user selection of one of the objects enables manipulation of one or more other objects in the interactive canvas without an additional user selection of the one or more other objects.

An example as described alone or in combination with any of the other examples described above or below, further comprising instructions that are executable by the at least one processor to disable the object selection mode and initiate the anchor mode in response to detecting an additional trigger event to disable the object selection mode, the additional trigger event comprising an additional user selection of an area of the interactive canvas that does not include an object.

An example as described alone or in combination with any of the other examples described above or below, wherein the computing device comprises a dual-display device comprising a first display device and a second display device, and wherein the interactive canvas is displayed on both the first and second display devices of the dual-display device as pages of a journal application.

In one or more examples, one or more computer-readable storage devices comprises instructions stored thereon that, responsive to execution by one or more processors of a computing device, performs operations comprising: receiving user input to an interactive canvas displayed on one or more display devices of the computing device; in an anchor mode, digitizing and displaying the user input to an interactive canvas and preventing the user input from being interpreted as input to manipulate one or more objects in the interactive canvas; and in an object selection mode, causing the user input to be interpreted as input to manipulate the one or more objects and preventing the user input from being digitized and displayed on the interactive canvas.

An example as described alone or in combination with any of the other examples described above or below, wherein the operations further comprise monitoring for a trigger event to switch between the anchor mode and the object selection mode.

Although the example implementations have been described in language specific to structural features and/or methodological acts, it is to be understood that the implementations defined in the appended claims is not necessarily limited to the specific features or acts described. Rather, the specific features and acts are disclosed as example forms of implementing the claimed features.

What is claimed is:

1. A method implemented by one or more computing devices, the method comprising:
generating digital content as an interactive canvas;
displaying the interactive canvas on one or more display devices of a computing device;
displaying, on the interactive canvas, additional digital content as one or more objects;
anchoring the one or more objects to the interactive canvas in an anchor mode, the anchoring preventing user input to the interactive canvas from being interpreted as input to manipulate the one or more objects;
detecting a trigger event to trigger an object selection mode; and
initiating the object selection mode in response to the trigger event, the object selection mode causing user input to the interactive canvas to be interpreted as input to manipulate the one or more objects.

2. The method of claim 1, wherein the object selection mode is configured to prevent the user input to the interactive canvas from being digitized and displayed as additional digital content on the interactive canvas.

3. The method of claim 1, wherein the anchor mode causes user input to the interactive canvas to be digitized and displayed on the interactive canvas as additional digital content.

4. The method of claim 1, wherein the object selection mode enables manipulation of each of multiple objects in the interactive canvas without an additional trigger event.

5. The method of claim 1, wherein the trigger event comprises a user selection of one of the objects anchored to the interactive canvas.

6. The method of claim 5, wherein the user selection comprises tapping and holding the object.

7. The method of claim 5, wherein the trigger event comprising the user selection of one of the objects enables manipulation of one or more other objects in the interactive canvas without an additional user selection of the one or more other objects.

8. The method of claim 1, further comprising displaying one or more visual indicators to indicate that the object selection mode is active.

9. The method of claim 1, further comprising disabling the object selection mode and initiating the anchor mode in response to detecting an additional trigger event to disable the object selection mode.

10. The method of claim 9, wherein the additional trigger event to disable the object selection mode comprises an additional user selection of an area of the interactive canvas that does not include an object.

11. The method of claim 1, wherein the interactive canvas is displayed on the one or more display devices as pages of a journal application.

12. A computing device comprising:
one or more display devices;
at least one processor; and
at least one computer-readable storage media storing instructions that are executable by the at least one processor to:
display an interactive canvas on the one or more display devices of the computing device;
anchor one or more objects to the interactive canvas in an anchor mode, the anchoring causing user input to the interactive canvas to be digitized and displayed on the interactive canvas;
detect a trigger event to trigger an object selection mode; and
initiate the object selection mode in response to the trigger event, the object selection mode causing user input to the interactive canvas to be interpreted as input to manipulate the one or more objects.

13. The computing device of claim 12, wherein the object selection mode is further configured to prevent the user input to the interactive canvas from being digitized and displayed on the interactive canvas.

14. The computing device of claim 12, wherein the anchor mode is further configured to prevent user input to the interactive canvas from being interpreted as input to manipulate the one or more objects.

15. The computing device of claim 12, wherein the trigger event comprises a user selection of one of the objects anchored to the interactive canvas.

16. The computing device of claim 15, wherein the user selection of one of the objects enables manipulation of one or more other objects in the interactive canvas without an additional user selection of the one or more other objects.

17. The computing device of claim 13, further comprising instructions that are executable by the at least one processor to disable the object selection mode and initiate the anchor mode in response to detecting an additional trigger event to disable the object selection mode, the additional trigger event comprising an additional user selection of an area of the interactive canvas that does not include an object.

18. The computing device of claim 13, wherein the computing device comprises a dual-display device comprising a first display device and a second display device, and wherein the interactive canvas is displayed on both the first and second display devices of the dual-display device as pages of a journal application.

19. One or more computer-readable storage devices comprising instructions stored thereon that, responsive to execution by one or more processors of a computing device, performs operations comprising:
receiving user input to an interactive canvas displayed on one or more display devices of the computing device;
in an anchor mode, digitizing and displaying the user input to an interactive canvas and preventing the user input from being interpreted as input to manipulate one or more objects in the interactive canvas; and
in an object selection mode, causing the user input to be interpreted as input to manipulate the one or more objects and preventing the user input from being digitized and displayed on the interactive canvas.

20. The one or more computer-readable storage devices of claim 19, wherein the operations further comprise monitoring for a trigger event to switch between the anchor mode and the object selection mode.
